(19) United States
(12) Patent Application Publication
(10) Pub. No.: US 2023/0257152 A1
(43) Pub. Date: Aug. 17, 2023

(54) METHODS AND MACHINERY FOR MANUFACTURING PACKAGING

(71) Applicant: CONVEYOR LIMITED, West Melton (NZ)

(72) Inventors: Richard Harry Davies, West Melton (NZ); Guy Benjamin Richard Davies, Christchurch (NZ)

(21) Appl. No.: 18/005,495

(22) PCT Filed: Jul. 13, 2021
(86) PCT No.: PCT/IB2021/056268

§ 371 Date: Jan. 13, 2023

(30) Foreign Application Priority Data
Jul. 13, 2020 (NZ) 766197

(51) Int. Cl. B65B 61/02; B65B 9/02; B26D 1/28; B26F 1/22

(52) U.S. Cl. CPC B65B 61/02; B65B 9/023; B26D 1/285; B26F 1/22; B65B 2220/06

(57) ABSTRACT

There is provided a method of manufacturing sachets. The method involves moving a web of semi-rigid material through a cutting station and simultaneously cutting a discrete cut in the web of semi-rigid material while the web of semi-rigid material continues to move through the cutting station. The method also includes sandwiching the web of semi-rigid material between a first flexible web of material and a second web of flexible material such that the first web of flexible material seals the discrete cuts in the semi-rigid web of material and the second web of flexible material forms a continuous elongate reservoir with the web of semi-rigid material. There is also provided an apparatus for cutting a web of material. The apparatus has a cutting roller and at least one cutting element protruding beyond the exterior surface of the roller, wherein the cutting element has a cutting profile that is at least partly a zigzag shape. Another apparatus for cutting a web of material the apparatus has a first cutting element and a second opposing cutting element, each cutting element having a cutting profile that is at least partly a zigzag shape. Each cutting element is associated with a cam and a rail that are arranged such that the first cutting element follows a path and the second cutting element follows a path that mirrors the path of the first cutting element. The paths have adjacent sections and/or intersecting sections in which the cutting elements come together to discretely cut the web of material while leaving the material intact.

### FIELD OF THE INVENTION

This invention relates to a method of manufacturing packaging. The invention also relates to machinery for manufacturing packaging.

### BACKGROUND

Known packages or sachets are made from layers of plastics and/or metallic foils that are laminated together to form a sealed reservoir between adjacent layers for housing the contents of the sachet. The layers are provided with weakened zones, which can be preferentially ruptured to allow the contents of the package to be discharged. The contents of the sachet can be dispensed, for example by an end user at a point of use, by piercing or rupturing at least one layer and thereby creating an opening through which the reservoir contents may be expelled, for example by squeezing the sachet.

Such sachets are typically manufactured using methods and apparatus similar to those used in the printing industry where elongate webs are passed along a line of stations, each performing a different function. Typically, the material to be packaged in the sachets is introduced between two webs, which are sealed together continuously along their opposite edges. The webs are also sealed transversely at intervals to divide the webs into separate compartments. Individual sachets are produced by cutting the webs transversely at the transverse seals.

Typically, a layer of the sachet is ruptured by flexing the sachet. The flexing ruptures a layer at a predetermined zone, which is typically a cut formed in at least one of the layers during manufacturing. The cut is performed by a stamping or pressing process at a cutting station. As the elongate web is being cut, the elongate web needs to be stationary or be moving very slowly. After cutting, the elongate web is advanced, and a new section of the elongate web is moved to the cutting station. The repetitive starting and stopping of the elongate web's movement can inhibit the speed of manufacturing. In some instances, the starting and stopping causes unnecessary wear and tear on the machinery. Further, the cutting process can often cause unwanted vibration.

It is an object of at least preferred embodiments of the present invention to provide a method and/or machinery to address the problems of the prior art. Additionally or alternatively, it is an object to of at least preferred embodiments to provide the public with a useful alternative.

### SUMMARY OF THE INVENTION

In accordance with a first aspect of the invention, there is provided a method of manufacturing sachets including: providing a web of semi-rigid material; moving the web of semi-rigid material through a cutting station and simultaneously cutting a discrete cut in the web of semi-rigid material while the web of semi-rigid material continues to move through the cutting station; and sandwiching the web of semi-rigid material between a first flexible web of material and a second web of flexible material such that the first web of flexible material seals the discrete cuts in the semi-rigid web of material and the second web of flexible material forms a continuous elongate reservoir with the web of semi-rigid material.

The method may further comprise filling the reservoir with a liquid, paste or similar substance.

The method may further comprise sealing the filled reservoir at discrete locations to form discrete reservoirs.

The method may further comprise cutting a plurality of discrete cuts and wherein each of the discrete reservoirs comprises a discrete cut.

The web of semi-rigid material and the first web of flexible material may be pre-laminated prior to the addition of the second web of flexible material.

The step of cutting the web of semi-rigid material may comprise cutting through the full thickness of the web of semi-rigid material.

The method may further comprise forming the reservoir by sealing the second web of flexible material to at least part of the first web of flexible material and/or the web of semi-rigid material at or near the edges of the webs of material.

The cut may be a zigzag cut.

In accordance with a second aspect of the invention, there is provided an apparatus for cutting a web of material, the apparatus comprising: a cutting roller having an axis of rotation and an exterior surface with an external circumference; and at least one cutting element protruding beyond the exterior surface of the roller, wherein the cutting element has a cutting profile that is an open profile and is at least partly a zigzag shape, and the cutting element has a longitudinal length extending in a direction generally perpendicularly to the axis of rotation of the roller, the longitudinal length being shorter than the circumference of the roller such that the at least one cutting element cuts a corresponding discrete zigzag cut in the web of material.

The entire cutting profile may be a zigzag shape.

The apparatus may further comprise an anvil roller having a substantially smooth surface, wherein the at least one cutting element of the cutting roller may be configured to operate against the substantially smooth surface of the anvil roller.

The at least one cutting element may comprise a first cutting element and a second cutting element.

The longitudinal axis of the first cutting element may be longitudinally aligned with the longitudinal axis of the second cutting element.

The length of the first cutting element combined with the length of the second cutting element may be shorter than the circumference of the roller such that the first cutting element cuts a corresponding first discrete zigzag cut in the web of material and the second cutting element cuts a corresponding second discrete zigzag cut in the web of material with a portion of un-cut material between the first zigzag cut and the second zigzag cut.

In accordance with a third aspect of the invention, there is provided an apparatus for cutting a web of material, the apparatus comprising: a first cutting element and a second opposing cutting element, each cutting element having a cutting profile that is an open profile and is at least partly a zigzag shape having a longitudinal length that extends in a direction generally parallel to a length of the web of material; each cutting element being associated with a cam for controlling vertical movement of the cutting element and horizontal movement of the cutting element; each cutting element being associated with a rail for restraining movement of the cutting element; wherein the cams and rails are arranged such that the first cutting element follows a path and the second cutting element follows a path that mirrors the path of the first cutting element; and wherein the paths have adjacent sections and/or intersecting sections in which the cutting elements come together to discretely cut the web of material while leaving the material intact.

The entire cutting profile may be a zigzag shape.

The term ‘comprising’ as used in this specification and claims means ‘consisting at least in part of’. When interpreting statements in this specification and claims which include the term ‘comprising’, other features besides the features prefaced by this term in each statement can also be present. Related terms such as ‘comprise’ and ‘comprised’ are to be interpreted in a similar manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting. Where specific integers are mentioned herein which have known equivalents in the art to which this invention relates, such known equivalents are deemed to be incorporated herein as if individually set forth.

As used herein the term ‘(s)’ following a noun means the plural and/or singular form of that noun.

As used herein the term ‘and/or’ means ‘and’ or ‘or’, or where the context allows both.

The invention consists in the foregoing and also envisages constructions of which the following gives examples only.

### BRIEF DESCRIPTION OF THE DRAWINGS

The present invention will now be described by way of example only and with reference to the accompanying drawings in which:

FIG. 1 is a schematic of a line for processing a web of material for packaging;

FIG. 2a is a schematic side view of a cutting station of the line of FIG. 1;

FIG. 2b is an end view of the cutting station of FIG. 2;

FIG. 3 shows a pair of opposing cutting elements;

FIG. 4 is a top view of one of the cutting elements of FIG. 3;

FIG. 5 is a perspective view of a roller including a cutting element;

FIG. 6 is another perspective view of a roller including a cutting element;

FIG. 7 is an end view of the roller of FIGS. 5 and 6 together with an anvil roller

FIG. 8 is a schematic side view of an alternative cutting station;

FIG. 9 shows a web of material after it passed through a cutting station;

FIG. 10 is a top view of a sachet; and

FIG. 11 is an exploded view of the sachet of FIG. 10.

### DETAILED DESCRIPTION

The technology described herein relates to apparatus and methods for forming packaging in the form of sachets. The sachets are used to package and dispense small predetermined quantities, e.g. single serves, of fluid or fluent materials such as liquids, creams, lotions, gels, pastes, powders, particulates, sauces, beverages, sunscreens, lubricants, paints, greases, oils, glues, resins, medicines, pharmaceuticals, etc. Such sachets can be made from multiple layers of sheet materials which are laminated together to form an enclosed reservoir. The layers of sheet material may be laminated together using heat, or glues/adhesives, or a combination of heat and glues/adhesives. The sachets are opened by bending the sachet to rupture one or more sachet layers. The sachet contents can be discharged through the rupture, the discharge being aided by squeezing the sachet if necessary.

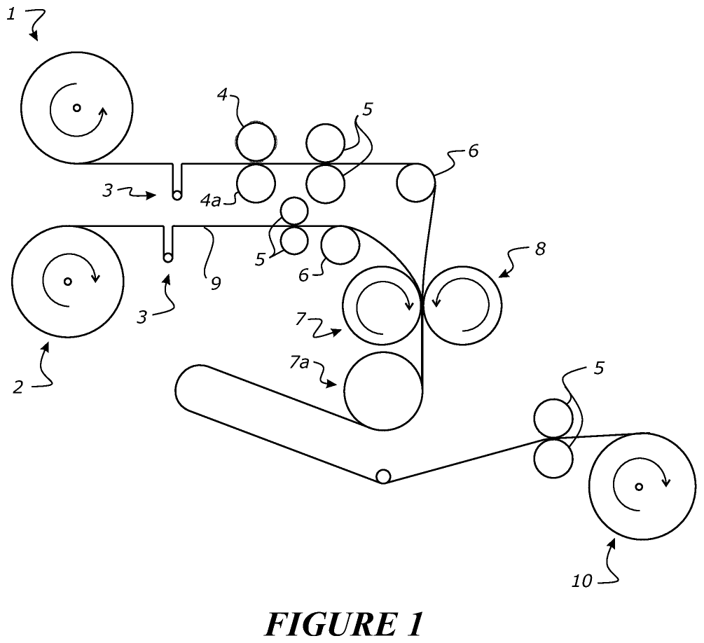

With reference to FIG. 1, there is shown a schematic of a line for processing a web of material 1, which ultimately will be a layer of a sachet. The web of material 1 can be any material known to be suitable for the manufacture of sachets and such like containers. Typical web materials include plastics (for example, polyethylene, polyethylene terephthalate, or polyethylene terephthalate glycol), metallic films, and paper or similar materials derived from wood fibre, either plain or treated with waxes or similar coatings. Other materials suitable for making sachets in accordance with the invention are bio-degradable plastics, for example plastics based on cornstarch, soya and/or potato, and polylactic acids (PLAs), the latter being suitable as a biodegradable replacement for polyethylene terephthalates (PETs).

FIG. 1 shows a first roll material 1 and a second roll of material 2. The first roll 1 of material is a semi-rigid material and the second roll of material 2 is a printed material. Each roll of material is tensioned by a tension control roller 3. The web of material 1 that is cut at the cutting station is a second layer 22 of three layers that are laminated together to form a sachet 19. A printed material 2 is a first layer 21 of the three layers of the sachet 19. The features of the sachet 19 and each layer are described in more detail below.

The processing line has an apparatus for cutting the web of material 1. The features and function of the processing line allow the web of material 1 to move through a cutting station of the processing line while being simultaneously cut. This allows the material 1 to move continuously from a previous station (or from the roll of raw material), through the cutting station, and onto a subsequent station without stopping. The cutting process is a continuous process.

In a first embodiment of the cutting station, the cutting station has a cutting roller 4. The cutting roller 4 has an axis of rotation about which the roller 4 rotates. The axis of rotation is a stationary axis that extends in a direction substantially perpendicular to the moving direction of the material.

The cutting roller 4 has an exterior surface with an external circumference. The cutting roller 4 has a smooth cylindrical surface, except for the at least one cutting element 4c protruding beyond the exterior surface of the cutting roller 4.

The cutting element 4c has a cutting profile that is an open profile. That is, the cutting profile is shaped such that when the cutting element 4c cuts through the material, the material remains intact. Apart from a shaped cut or slit, no material is removed from the web of material 1.

The cutting profile of the cutting element 4c is at least partly a zigzag shape. In addition, the cutting element 4c has a longitudinal length extending in a direction generally perpendicularly to the axis of rotation of the cutting roller 4. In the embodiment shown, the entire cutting profile is a zigzag shape.

Further, the longitudinal length of the cutting element 4c is shorter than the circumference of the cutting roller 4. The cutting element 4c has a first end and a second end between which the longitudinal length extends. There is a portion of the roller between the second end of the cutting element 4c and the first end of the cutting element 4c that is smooth and free of the cutting element 4c. As a result, the at least one cutting element 4c cuts a corresponding discrete zigzag cut 17 in the web of material 1.

The zigzag cut 17 is not a continuous cut. There is a portion of un-cut material between the first zigzag cut 17 and the second zigzag cut 17. The length of the zigzag cut 17 corresponds to the length of the zigzag cutting element 4c and the length of the portion of un-cut material between the zigzag cut 17 and a following zigzag cut corresponds to the distance between the second end of the cutting element 4c and the first end of the cutting element. As the cutting roller 4 rotates continuously and the web of material 1 moves through the cutting station, the cutting roller 4 will form a series of discrete cuts in the material with portions of uncut material between a cut, a previous cut and following cut.

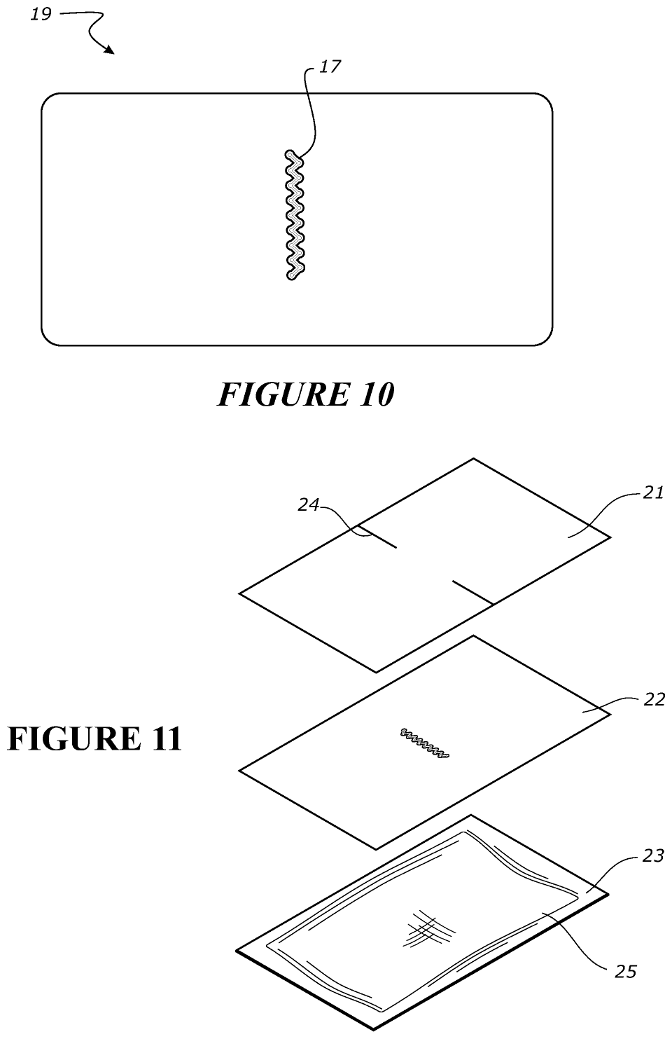

In the embodiment shown, the zigzag cut 17 is surrounded by a recess 17b. With reference to FIG. 10, 17a indicates the cut and 17b indicated the recess. The recess has a shape corresponding to the zig zag shape of the cut 17a. That is, the recess is also a zigzag shape. From the substantially planar surface of the material, the recess is angled downwardly and inwardly towards the cut 17a.

In alternative embodiments, any suitable number of cutting elements 4c having any suitable spacing may be used. In the embodiment shown, the cutting elements 4c are equally spaced around the roller. At least one of the cutting elements has a longitudinal axis that is substantially perpendicular to the roller axis. In the embodiment shown, both of the cutting elements have a longitudinal axis that is substantially perpendicular to the roller axis.

The cutting station further comprises an anvil roller 4a. The anvil roller 4a has a substantially smooth cylindrical surface. The entire surface of the anvil roller 4a is substantially smooth. The at least one cutting element 4c of the cutting roller 4 is configured to operate against the substantially smooth surface of the anvil roller 4a. The surface of the anvil roller 4a is a hardened surface for the cutting element 4c to cut against.

In the embodiment shown, the cutting roller 4 has more than one cutting element 4c. In particular, the at least one cutting element 4c comprises four cutting elements 4c.

The length of all of the cutting elements combined together is shorter than the circumference of the roller such that each cutting element cuts a corresponding first discrete zigzag cut 17 in the web of material 1 and the following cutting element 4c cuts a corresponding discrete zigzag cut 17 in the web of material 1 with a portion of un-cut material between the zigzag cuts. The longitudinal axis of the first cutting element 4c is longitudinally aligned with the longitudinal axis of the second cutting element. As a result, the roller creates a series of longitudinally aligned and discrete cuts in the web of material 1.

In alternative embodiments, the roller could be any other suitable shape with cutting elements. For example, the portions of the roller extending between the cutting could have a convex shape or a concave shape.

In an embodiment, the material 1 is modified prior to being cut. For example by adding registration markers 18 to facilitate timing of machine operations. The registration markers are shown in FIG. 9.

The axle of the cutting roller 4 is driven, for example by a servo motor. In an embodiment, one or more registration marker sensors 9 detect the location of a registration marker 18. One or more roller sensors detect the location of the cutting element(s). The location of the registration marker 18 is compared to the location of the cutting element 4c by a control system. The control system adjusts the speed of rotation of the roller to ensure the cutting element(s) is/are correctly located in relation to the registration marker 18. This process ensures the material 1 is cut in the correct location.

The anvil roller 4a is not a driven roller. The anvil roller 4a is a freewheeling roller that moves as a result of the force(s) applied by the cutting roller 4 and/or the web of material 1.

Driving the cutting roller 4 rotation ensures that the cutting element 4c making the cut is moving at substantially the same speed as the material, that is being cut. This ensures a high-quality cut is formed. If the cutting roller 4 was not driven and was instead free rolling, the cutting elements 4c could slip relative to the material, leading to a poor-quality cut.

After the cutting station, the line also includes a pair of tension roller 5. The line also includes a load cell 6.

The line further includes a hot laminating roller 7 and associated pinch roller 8. The hot laminating roller 7 and the pinch roller 8 laminate the two webs of material 1, 2 together by heating one or both webs of material. Subsequently, the laminated materials 1, 2 pass over a cooling roller 7A. The cooling roller 7A cools the materials 1, 2, which sets or cures the lamination between the materials. As mentioned earlier, the layers of sheet material may be laminated together using heat, or glues/adhesives, or a combination of heat and glues/adhesives. If the layers of sheet material are laminated together using glues/adhesives, the roller 7 will include a glue/adhesive applicator and may not be a hot or heated roller. Further, the line would include a curing zone with features for curing the glues/adhesives, such as UV heaters

The final step of the line is a roll of finished product 10 that is now ready to be taken away and run through a packaging machine to make single serve packs.

In a second embodiment of the cutting station, the cutting station has a pair of cam controlled cutting elements 15.

Similar to the first embodiment of the cutting station, the cutting elements 15 each have a cutting profile that is an open profile. The cutting profile is also a zigzag shape. Unless described below, the cutting element 15 and cut that is formed by the cutting element have the same features and functionality of the cutting element 4c and cut that is formed by the cutting element of the first embodiment described above.

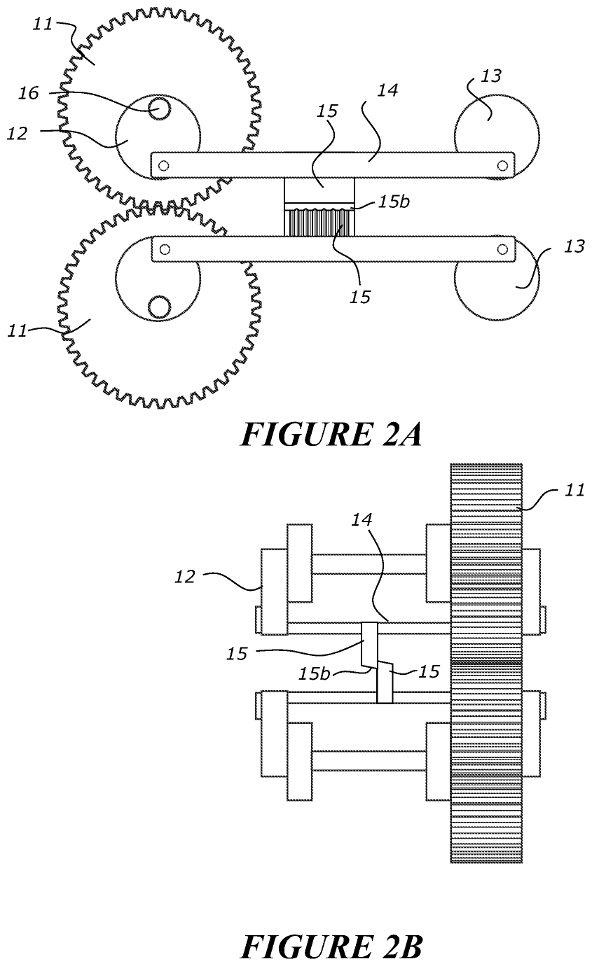

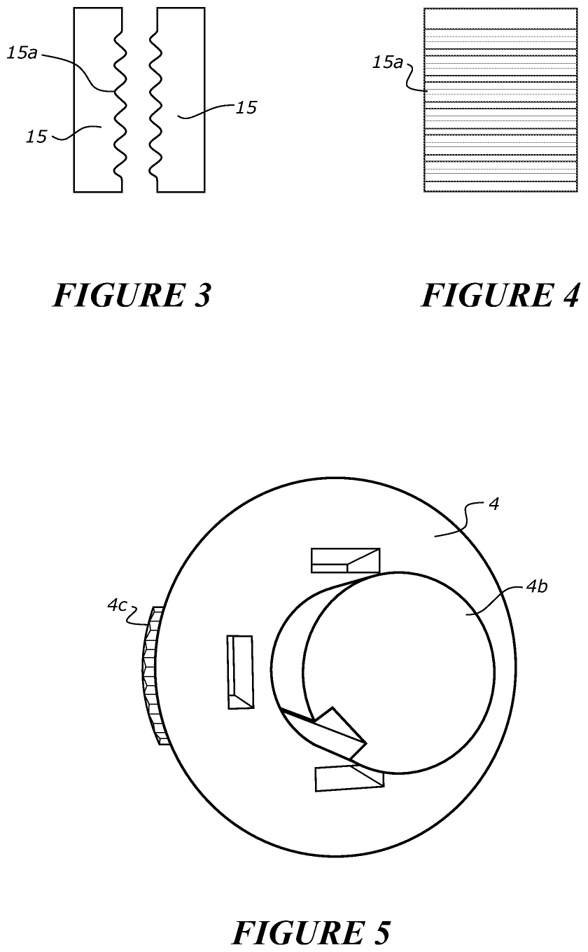

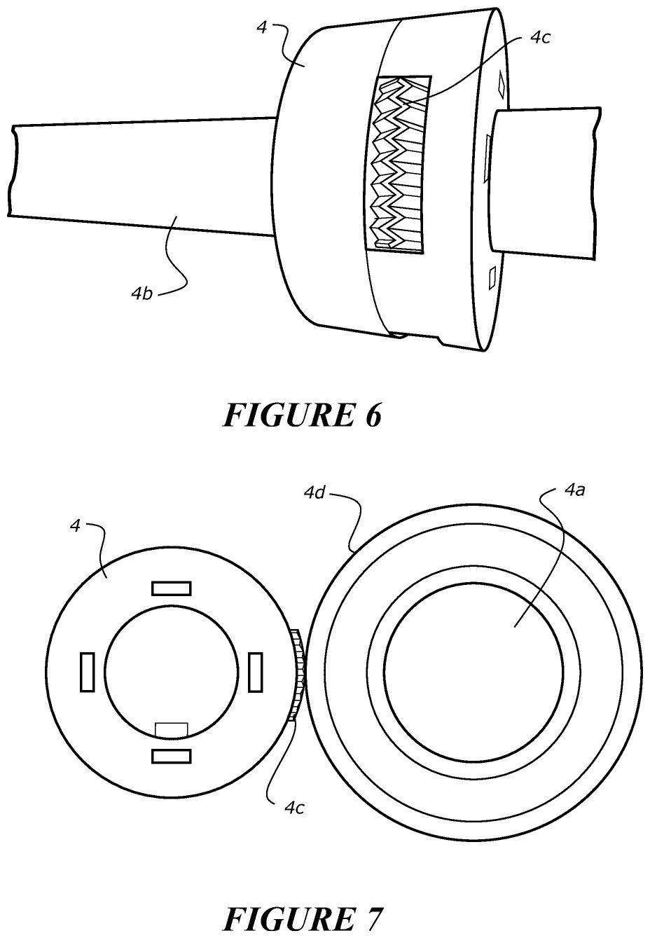

In this embodiment, there are two cutting elements 15 that are integral with opposing jaws. FIG. 2 shows an upper (or first) cutting element 15 and a lower (or second) cutting element 15. The cutting elements 15 oppose each other. As will be described in more detail below, the two cutting elements 15 come together to cut the web of material 1.

Each cutting element 15 is mounted on one or more rail or connecting rods 14. The rails extend horizontally. The cams together with the rails allow each cutting element 15 to move horizontally and vertically.

Each rail extends between a pair of cams 12. Each cam 12 is fixed to a gear in an offset or eccentric location. As the gears rotate, the cams follow a circular reciprocating path, which is described in more detail below.

Each cutting element 15 is at an initial vertical distance away from the material 1 that allows the material to move between the cutting elements without being cut or catch on one or both of the cutting elements. For example, the initial vertical distance is a distance such that each cutting blade is at least about 2 mm away from the surface of the web of material 1.

The amount of vertical movement allows the cutting elements 15 to move from the initial starting height towards the web of material 1 and to then cut the web of material 1. After the material 1 is cut, the cutting elements 15 then retreat back to their original vertical location.

Each cutting element 15 is at an initial horizontal location relative to a stationary frame or chassis of the cutting station. The cutting element 15 then moves forward in the same direction as the web of material 1. The speed of the cam in the horizontal direction is matched to be the same as the speed at which the web of material 1 travels through the cutting station between the cutting elements.

The cam 12 and rail 14 arrangement allow the vertical movement and horizontal movement to create the movement required to cut the web while allowing the web to continue moving through the production line.

The movement of the lower cutting element 15 mirrors the movement of the upper cutting element. The movement of the upper cutting element 15 will now be described and it will be appreciated that the lower cutting element 15 follows a similar path.

The location of the cutting elements will be described with reference to clock positions. The cutting elements follow a circular path. From an initial starting location at a 12 O'clock position, the cutting elements move rearwardly compared to the direction of travel of the web of material 1 and then starts to move downwardly towards the web of material 1. When the cutting element 15 is halfway along the vertical path of the movement (9 O'clock position), the cutting element 15 will momentarily halt moving rearwardly in a horizontal direction then start to move forwardly in the horizontal direction. The cutting element 15 will continue moving downwardly and forwardly along the circular path until it reach the lowest point of its travel (6 O'clock position) at which point the cutting element 15 will have cut through the web of material 1. When in this position, the opposing cutting elements 15 will have adjacent overlapping sections, shown in FIGS. 2a and 2b. The cutting element 15 then moves in the horizontal direction at the same speed, or very close to the same speed, as the speed of the web. This ensures the web of material is cut by the cutting elements and the cutting elements do not tear, rip, or cause other damage to the web of material as it is being cut.

After reaching the lowest point of travel, the cutting element 15 then begins to move upwardly and away from the web of material 1 while still moving forwardly in a horizontal direction. The cutting element 15 continues to move upwardly and then momentarily ceases to move horizontally when it reaches the 3 O'clock position. The cutting element 15 then starts to move rearwardly in the horizontal direction, which is the opposite direction to the direction of the web travel. The cutting element 15 continues to move upwardly until it returns to the initial starting height at which point it stops moving upwards and the path is completed.

The process described above is repeated with one zig zag cut being formed in the web of material 1 for each cycle.

This cam and rail arrangement described above results in a smooth mechanism which allows the two cutting elements to meet together to perform a cut then quickly retract, with no adverse vibration. The gears are spur gears with no backlash, which contribute towards the smooth running of this mechanism.

Similar to the first embodiment, one or more registration marker sensors 9 detect the location of a registration marker 18. One or more cutting element sensors detect the location of the cutting element(s). The location of the registration marker 18 is compared to the location of the cutting element 15 by a control system. The control system adjusts the speed of the cams 12 to ensure the cutting element(s) is/are correctly located in relation to the registration marker 18. This process ensures the material is cut in the correct location.

Each cutting element 15 has a longitudinal length extending in a direction generally parallel to the length of the web of material 1. In the embodiment shown, each cam has a single cutting element.

Similar to the first embodiment, the cutting elements of this embodiment cut a discrete zigzag cut 17 in the web of material 1. As the cam controlled cutting elements 15 operate continuously and the web of material 1 moves through the cutting station, the cam controlled cutting elements 15 will form a series of discrete cuts in the material with portions of uncut material between a cut, a previous cut and following cut.

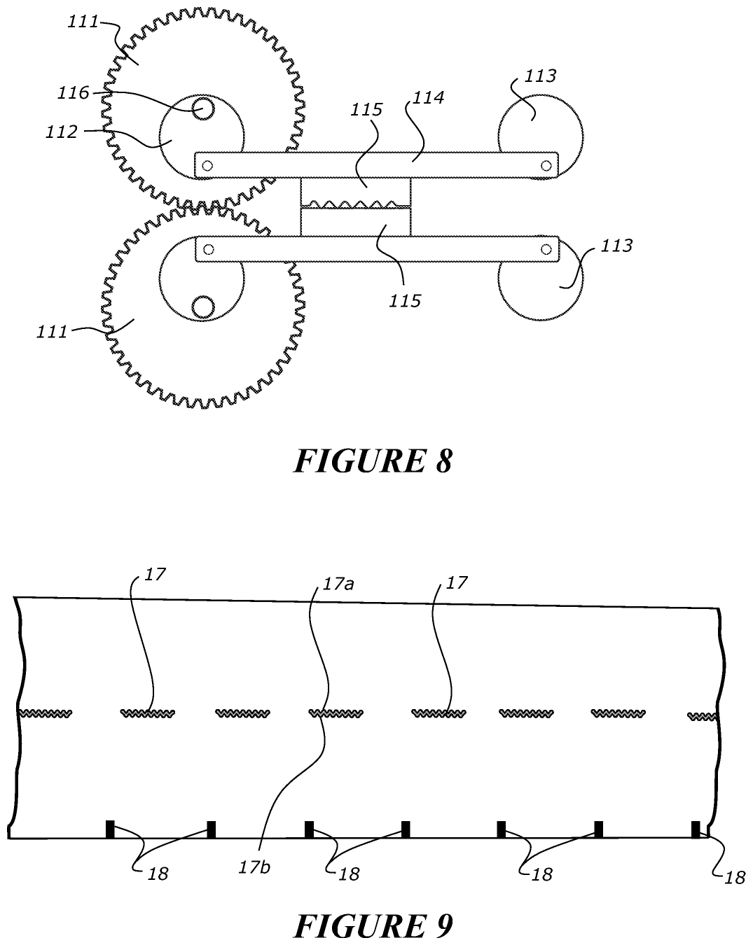

FIG. 8 shows an alternative cutting station. As can be seen from FIG. 8, this cutting station is similar to the cutting station shown and described in relation to FIG. 2. Similar features are indication with similar numbers, with the addition of 100. The features and functions of the cutting station of FIG. 8 are the same as those of the cutting station in FIG. 2, except as described below.

In this cutting station, rather than having two opposing cutting elements 15, one of the jaws 115 is a flat anvil. FIG. 8 shows the lower jaw 115 is a flat anvil. In an alternative embodiment, the upper jaw may be a flat anvil and the lower jaw may have the zigzag cutting element. The anvil has a substantially smooth flat surface. The entire surface of the anvil is substantially smooth. The at least one cutting element 115c of the upper jaw 115 is configured to operate against the substantially smooth surface of the anvil 116. The surface of the anvil 116 is a hardened surface for the cutting element 4c to cut against.

In addition to the cutting station (which may be any one of the embodiments described above), the processing line for cutting a web of material 1 has a drive system for driving the web of material 1. The drive system operates continuously.

The drive system may include a belt that drives the material, toward the cutting station at a substantially constant speed. The belt is held under tension by the rollers 3, 5 in combination with the cutting roller and the anvil roller 4a. One or more of the rollers, may be a driving roller that drives the belt.

In the embodiment shown in FIG. 1, the rollers are arranged to introduce the sheets of web of material 1, to the cutting element at a substantially horizontal orientation.

The process line may have a subsequent station for sealing webs of materials 1 and 2 with a third web of material. The three webs of material are sealed together continuously along their opposite edges to form two substantially parallel longitudinal webs. The longitudinal webs may be formed by any suitable process, such as a conventional continuous heat-sealing process. In the embodiment shown, the sheets of web of material 1, are received between two cylindrical rollers. One of the cylindrical rollers has heated portions at either end (not illustrated) that apply heat to the edges of the sheets of web of material 1, to form the longitudinal webs. The cylindrical rollers, form two continuous, spaced apart longitudinal seals along opposite edges of the sheets of web of material 1. Fill product is introduced between the longitudinal webs.

The process line may have a subsequent station for separating the sealed reservoirs into individual packages.

The method may form sachets as an interconnected series of sachets which is formed, loaded with sachets contents, sealed, and separated into individual sachets or into groups of sachets.

FIGS. 10 and 11 show a sachet 19 formed by the method and machinery described herein. The sachet 19 has three layers 21, 22, 23 spaced apart from one another. The three layers 21, 22, 23 are shown apart for the purposes of explanation and as may be envisaged prior to being brought together and laminated to one another to form a sachet. Each of the webs of material form a layer of the sachet 19. FIG. 11 may also be envisaged as so-called ‘exploded’ views of the respective sachets.

A first sachet layer 21 optionally has a line or lines of weakness 24. A second sachet second layer 22 has a line or weakness or cut 17 formed in a mid-portion of the layer, i.e. inward of the periphery of the second layer 22. Each cut 17 in the second web layer 22 extends through the full thickness of the layer 22. A third sachet layer 23 has a reservoir 25 formed in a mid-portion of the layer, i.e. inward of the periphery of the third layer 23.

The cut is a zigzag cut 17, which is formed by the machinery and method described above. The zigzag cut 17 is positioned in the middle of the sachet 19. The zigzag cut 17 has a longitudinal length, which extends in a direction generally parallel to the edges of the sachet 19. The cut 17 is located on a centreline of the sachet 19. Alternatively, the cut can be offset from a centreline of the sachet 19. As described above, the zigzag cut 17 is surrounded by a recess 17b.

The three layers are formed into a sachet 19 by laminating the first, second and third layers together. The first layer is sealed to one face of the second layer. The third layer 23 is fixed to the opposite face of the second, or intermediate, second layer.

The first layer and the third layer 23 are relatively flexible while the second layer 22 is semi-rigid. That is, the second layer 22 is more rigid than the first layer and more rigid than the third layer 23. The second layer 22 bends in the vicinity of the cut upon flexure of the sachet 19 about the line or lines of weakness.

FIG. 9 shows top plan views of the three layers of the sachet of FIG. 8 when assembled together and laminated to form the sachet. The sealing of the first layer to the upper face of the second layer 22 seals over and around the cut 17. The first layer and the second layer 22 are sealed together over their whole faces.

The fixing of the third layer 23 to the lower face of the second layer 22 seals the peripheral region of the third layer 23, i.e. the portion of the third layer 23 outside the reservoir 25 to a corresponding peripheral region of the second layer. The outline of the reservoir is shown in FIG. 11.

The first layer and the second layer 22 of the sachet 19 are planar and the reservoir 25 of the third layer 23 houses the contents of the sachet between the second and third layers.

The third layer 23 may have the reservoir 25 formed as a pre-shaped pouch, such as by vacuum forming, before filling the reservoir 25 and fixing the perimeter of the third layer 23 to the perimeter of the lower face of the second layer. Alternatively, the reservoir 25 is not pre-shaped. The shape of the reservoir 25 is instead formed by the introduction of the sachet contents (not shown) when assembling the sachet 19. In this case, the third layer 23 is fixed to the lower face of the second layer 22 with sufficient fullness to accommodate the sachet contents in the reservoir 25 space between the substantially flat second layer 22 and the relatively looser third layer 23.

The cut in the second layer 22 extends through the full thickness of the second layer. Alternatively, the cut can be formed only partially through the second layer 22 in which case, when the sachet is to be opened, the second layer 22 is ruptured at the cut which then extends completely through the second layer 22 to form an opening through which the contents of the reservoir 25 can be discharged. The opening of the sachet will be discussed further below.

To open the sachet 19, a compression force is applied between opposite edges of the sachet on opposite sides of the cut. The compression force flexes the sachet 19 preferentially about the cut so that the second layer 22 fractures at the cut and portions of the second layer 22 on opposite sides of the cut move apart. If the movement is sufficient it ruptures the first layer in the vicinity of the cut to form a discharge opening through which contents of the sachet may be discharged. When the cut fractures, the fingers are separate from one another. Alternate fingers extend as cantilevers in opposite directions.

In particular, as the sachet 19 flexes, at least the tip of each finger portion of the second layer 22 progressively moves away from the immediately adjacent surrounding portions of the second layer. This displacement of the fingertips ruptures the first layer, initially at each fingertip. As the sachet 19 is flexed further, the initially separate rupture points in the first layer extend generally along the common portion of the line of weakness between the adjacent fingers to merge into a single enlarged discharged opening.

The sachet 19 may be opened by folding the two parts of the sachet on opposite sides of the line or lines of weakness in either of two directions. In a first option, the sachet 19 is opened by folding the two sachet parts to close in around the reservoir 25 pouch. In this option, the contents in the reservoir 25 pouch can be expelled by squeezing the reservoir 25 between the two parts of the sachet. In a second option, the sachet 19 is opened by bending the two sachet parts back away from the reservoir 25 to stretch the reservoir 25 around the outside of the bending sachet 19. In this option, the contents in the reservoir 25 pouch can be expelled by tightening the reservoir 25 in this way. The first-mentioned method of opening the sachet is preferred because the outer sealing layer is stretched around the outside of the bending sachet 19 and is then more easily ruptured by the outward displacement of the fingertips.

If the cut was formed only partially through the second layer, the cut ruptures completely through the full thickness of the layer when the portions of the second layer 22 on opposite sides of the cut are displaced and move apart.

Forming an elongate web comprising a lamination of two web layers. Forming a series of lines of weakness or cuts (for example, each being a cut as described above) is in a mid-width portion of the second web layer. Sealing the web layers face to face so that the first layer seals over and around each cut.

The machinery and method described herein are suitable for packaging fluid or fluent material or product, such as liquids or flowable powders. The size of the machine and/or components of the machine can be adapted to make packages of any size. In an embodiment, the machine is adapted to produce packages having a volume of about 2 mL or about 5 mL. In another embodiment, the machine is adapted to produce packages having a volume of about 1 L or more. The machine may be adapted to produce packages having any other suitable volume, for example about 10 mL, about 20 mL, about 50 mL, about 75 mL, about mL, about mL, about mL, about mL or about 2 L.

Preferred embodiments of the invention have been described by way of example only and modifications may be made thereto without departing from the scope of the invention.

For example, it will be appreciated that sachets and preparatory or precursor materials for making the sachets can be implemented in various forms while incorporating the current technology. The description above refers to the embodiments shown in the drawings which are given, by way of example only. However, it is to be understood that the technology is not limited to the embodiments shown and may also be applied to packaging or sachets having more than the number of layers shown and described, for example.

For example, when sachets are produced as groups of joined sachets, the joined sachets may be intended to remain together in use, such as when two or more different materials are contained in respective sachets of two or more grouped sachets, e.g. for simultaneous dispensing such as may be required in a two-part resin formulation. Alternatively the joined sachets may be joined in a manner allowing easy separation, for example at point of sale, or just prior to use.

1. A method of manufacturing sachets comprising:
providing a web of semi-rigid material;
moving the web of semi-rigid material through a cutting station and simultaneously cutting a discrete cut in the web of semi-rigid material while the web of semi-rigid material continues to move through the cutting station, the step of cutting the web of semi-rigid material comprises cutting through the full thickness of the web of semi-rigid material; and
sandwiching the web of semi-rigid material between a first flexible web of material and a second web of flexible material such that the first web of flexible material seals the discrete cuts in the semi-rigid web of material and the second web of flexible material forms a continuous elongate reservoir with the web of semi-rigid material.

2. The method according to claim 1, further comprising filling the reservoir with a liquid, paste or similar substance.

3. The method according to claim 1, further comprising sealing the filled reservoir at discrete locations to form discrete reservoirs.

4. The method according to claim 1, wherein the method comprises cutting a plurality of discrete cuts and wherein each of the discrete reservoirs comprises a discrete cut.

5. The method according to claim 1, wherein the web of semi-rigid material and the first web of flexible material are pre-laminated prior to the addition of the second web of flexible material.

6. The method according to claim 1, further comprising forming the reservoir by sealing the second web of flexible material to at least part of the first web of flexible material and/or the web of semi-rigid material at or near the edges of the webs of material.

7. The method according to claim 1, wherein the cut is a zigzag cut.

8. An apparatus for cutting a web of material, the apparatus comprising:
a cutting roller having an axis of rotation and an exterior surface with an external circumference; and
at least one cutting element protruding beyond the exterior surface of the roller, wherein the cutting element has a cutting profile that is an open profile and is at least partly a zigzag shape, and the cutting element has a longitudinal length extending in a direction generally perpendicularly to the axis of rotation of the roller, the longitudinal length being shorter than the circumference of the roller such that the at least one cutting element cuts a corresponding discrete zigzag cut in the web of material.

9. The apparatus of claim 8, wherein the entire cutting profile is a zigzag shape.

10. The apparatus of claim 8, further comprising an anvil roller having a substantially smooth surface, wherein the at least one cutting element of the cutting roller is configured to operate against the substantially smooth surface of the anvil roller.

11. The apparatus of claim 8, wherein the at least one cutting element comprises a first cutting element and a second cutting element.

12. The apparatus of claim 11, wherein the longitudinal axis of the first cutting element is longitudinally aligned with the longitudinal axis of the second cutting element.

13. The apparatus of claim 12, wherein the length of the first cutting element combined with the length of the second cutting element is shorter than the circumference of the roller such that the first cutting element cuts a corresponding first discrete zigzag cut in the web of material and the second cutting element cuts a corresponding second discrete zigzag cut in the web of material with a portion of un-cut material between the first zigzag cut and the second zigzag cut.

14. An apparatus for cutting a web of material, the apparatus comprising:
a first cutting element and a second opposing cutting element, each cutting element having a cutting profile that is an open profile and is at least partly a zigzag shape having a longitudinal length that extends in a direction generally parallel to a length of the web of material;
each cutting element being associated with a cam for controlling vertical movement of the cutting element and horizontal movement of the cutting element;
each cutting element being associated with a rail for restraining movement of the cutting element;
wherein the cams and rails are arranged such that the first cutting element follows a path and the second cutting element follows a path that mirrors the path of the first cutting element;
and wherein the paths have adjacent sections and/or intersecting sections in which the cutting elements come together to discretely cut the web of material while leaving the material intact.

15. The apparatus of claim 14, wherein the entire cutting profile is a zigzag shape.
